(19) United States
(12) Patent Application Publication
(10) Pub. No.: US 2002/0105948 A1
(43) Pub. Date: Aug. 8, 2002

(54) Superconducting packet switch

(76) Inventor: Walter L. Glomb, Ellington, CT (US)

Correspondence Address: LYON & LYON LLP, 633 WEST FIFTH STREET, SUITE 4700, LOS ANGELES, CA, 90071, US

(21) Appl. No.: 10/067,430

(22) Filed: Feb. 5, 2002

Related U.S. Application Data
(60) Provisional application No. 60/267,236, filed on Feb. 6, 2001.

(51) Int. Cl. H04L 12/50; H04L 12/26

(52) U.S. Cl. 370/369; 370/386; 370/389; 370/252

(57) ABSTRACT

A packet router uses high-speed superconducting circuits to process incoming data bits, read the packet header, and pass the packet header to a non-superconducting semiconductor controller. The controller determines the appropriate destination for the packet, and sends corresponding control signals to a superconducting router. The superconducting router routes each packet to its intended destination based on these control signals.

### CROSS-REFERENCE TO RELATED APPLICATIONS

Priority is claimed to U.S. provisional patent application No. 60/267,236, filed Feb. 6, 2001, which is incorporated herein by reference.

### BACKGROUND OF THE INVENTION

1. Field

The field of the present invention relates to communications of packet data over networks.

2. Background Art in the Field of Internet Routers

Internet data traffic is presently growing by 100% per year as the use of broadband technologies such as DSL, cable modems, DWDM metro rings, and gigabit Ethernet become more widespread. Telecommunications carriers are struggling to upgrade and expand the capacity of the high-speed, fiber-optic, long-haul circuits in the core of the network that carry the bulk of the Internet's data across continents and under the seas. With one billion telephone lines and 500 million personal computers in the world today, it is expected that these long-haul circuits will soon be asked to transport many thousands of terabits per second.

Conventional packet routers exist for switching TCP/IP packets to their intended destination. Typically, such routers route any of their N inputs to any of their N outputs. When a packet of data arrives at such a router from any of the N inputs, the router extracts the address of the destination node from the packet's header and determines, based in the extracted address, which one of the N outputs the packet should be sent to. This determination is commonly implemented using large address look-up tables that map particular addresses onto each of the physical output ports of the router.

The speed of conventional packet routers is currently limited to 10 Gigabits/sec (Gbps) for a number of reasons: the current generation of optical modulators (e.g., InP modulated sources and LiNbO₃ external modulators) cannot operate any faster; the current generation of photodetectors (e.g., InGaAs p-i-n and Schottky photodiodes) cannot operate any faster; and the electronics that process the received signals cannot operate any faster.

Because existing routers can only operate at up to 10 Gbps, while the data-carrying bandwidth of existing optical fiber is about 10 THz, dense wavelength division multiplexing (DWDM) is commonly used to send multiple 10 Gbps signals along a single fiber. In DWDM systems, the 10 THz bandwidth is divided up into a plurality of channels (e.g., 100 channels, each of which is 100 GHz wide). Each of these channels is then used to transmit a 10 Gbps signal through the same fiber. The signals are then separated at the receiving end using wavelength selective devices. This arrangement increases the data carrying capacity of the fiber itself (as compared to sending a single 10 Gbps channel of data over the fiber), but has a number of serious drawbacks. First, it does not make efficient use of the capacity of the fiber, because even the densest DWDM systems can only send 1 Terabits per second through a fiber, which leaves 80% of the fiber's theoretical data-carrying capacity unused. In addition, for each additional 10 Gbps of data that is sent through the fiber, an additional copy of hardware is required. For example, a system that sends sixteen 10 Gbps signals through a single fiber using DWDM will require 16 times as much hardware at each end of the fiber than a system that sends a single 10 Gbps signal through the same fiber. Notably, in such systems, the only place where the data rate ever exceeds 10 Gbps is in the fiber itself. Using DWDM to increase data capacity is therefore expensive, because the cost of the electronics increases linearly with the increase in capacity (because each channel requires its own regenerators and a dedicated port on each router or switch).

3. Background Art in the Field of Superconducting Routers

A superconducting switching system that can route signals at much higher speeds than the above-described electronic circuitry is described in Feasibility Study of RSFQ-based Self-Routing Nonblocking Digital Switches by D. Zinoviev et al., IEEE Trans. on Appl. Supercond. 7, No. 2, 3155-3163 (1997), which is incorporated herein by reference and referred to hereinafter as “Zinoviev.” But in order to operate the Zinoviev switching system, routing bits that specify a particular path through the network must be appended to each packet in advance. These routing bits specify which of the physical output ports the incoming packet should be sent to, for each switch in the signal path. As a result of this configuration, the Zinoviev system cannot be used for Internet communications, because the standard TCP/IP message protocol only includes a four byte IP address (e.g., 130.132.200.250) that specifies the final destination of the packet, and does not specify the particular route through the network that should be used to get the information from its source to its destination. To the contrary, conventional IP envisions that a packet may travel from its source to its destination over a plurality of different physical paths.

### DETAILED DESCRIPTION OF THE PREFERRED EMBODIMENTS

The inventor has recognized that using DWDM to combine a plurality of signals that travel along the same fiber location wastes a significant portion of the fiber's data-carrying capacity (due in part to the spacing between adjacent channels), and that sending a smaller number of higher data-rate signals results in a more efficient utilization of bandwidth. For example, sending a single 160 Gbps signal through a fiber uses less bandwidth than sending sixteen 10 Gbps signals through the same fiber using DWDM.

The inventor has also recognized that superconducting routing circuitry may be used to process signals having very high data rates (e.g., 160 Gbps) that cannot be processed by conventional electronics.

The inventor has further recognized that it would be impractical to implement an all-superconducting router with a conventional architecture (e.g., using a routing architecture that uses address tables at each switch in the network to select a physical output port based on the destination information contained in each packet's header), due to the relatively small size of practical superconducting address table circuits as compared to their semiconductor counterparts, and due to the difficulties of cooling large superconducting circuits.

The inventor has further recognized that not all the information in a router has to operate at the speed of the incoming data bits (hereinafter the “wire rate”)—some of the circuitry can operate at the speed of the incoming packets (hereinafter the “packet rate”). For example, if a 160 Gbps packetized data stream arrives at a given input port, and the smallest packet contains 512 bits of data, then the packet rate would be 310 million packets per second (Mpps). In this case, because all the data in any given packet is routed to the same address, the part of the circuit that decides where to route each incoming packet only has to make one routing decision every 3.2 nanoseconds.

The inventor has further recognized the benefits of mixing superconducting and non-superconducting electronic circuits in a single system, such that wire-rate signals are processed by superconducting circuits, and decisions that only have to occur at the packet rate are made using non-superconducting electronic circuits that run at the slower packet rate. In the example mentioned above (where the data arrives at 160 Gbps, and the packets arrive at 310 Mpps), the wire rate signals could be processed by superconducting circuits operating at 160 GHz, and the slower packet rate decisions would be made using non-superconducting electronic circuits operating at 310 MHz (or even slower, if pipelining is used).

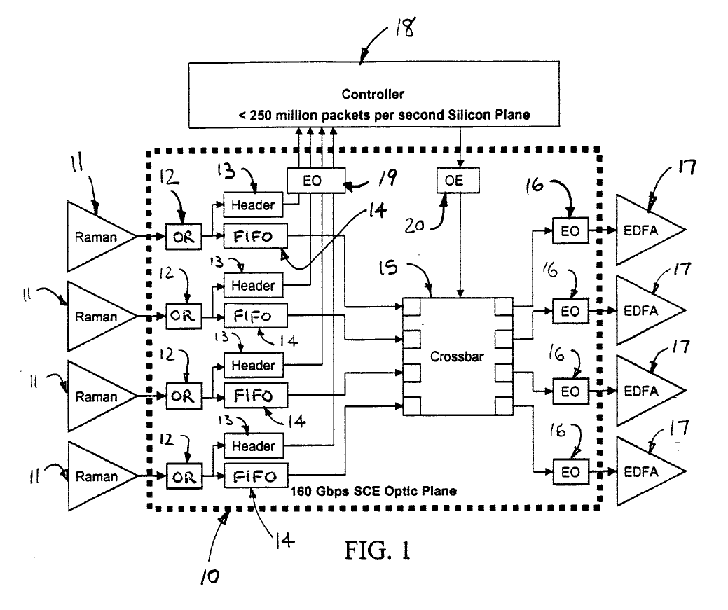

FIG. 1 is a block diagram of a preferred mixed superconducting / non-superconducting electronics router in accordance with a preferred embodiment. It includes three different types (or “planes”) of active components: a high-speed section 10 that is implemented with superconducting components, a controller 18 that is implemented with non-superconducting semiconductor components, and optical amplifiers 11 and 17. Note that while a 4×4 router is illustrated, this architecture can be easily extended to other sizes (e.g., 1×4, 8×8, 16×16, etc.), as will be appreciated by persons skilled in the relevant art.

The function of the FIG. 1 router is to receive digital data packets on any of its input ports and forward them to the appropriate output port. The decision to send a given packet to a particular output port is based on destination information that is contained within the data packet itself. In most common protocols, this data destination information is contained in the packet's header, and the remainder of this document assumes that to be the case. It is to be understood, however, that the destination information could alternatively be located in another portion of the packet, provided that suitable modifications are made.

Optical input signals, preferably on-off modulated serial digital data packets, arrive at one or more of the inputs of the four Raman amplifiers 11. Each Raman amplifier 11 serves as a low noise preamplifier for the incoming optical signals, and may be implemented using any suitable technology. Suitable Raman amplifiers are available from, for example, Corning, Inc. In alternative embodiments, other types of optical amplifiers may be substituted for the Raman amplifiers. In other alternative embodiments where the signal-to-noise ratio of the incoming signal is sufficiently high, the amplifiers may be omitted entirely.

The optical soliton pulse outputs of the Raman amplifiers 11 are provided to the superconducting optical receivers (OR) 12. These optical receivers include optoelectronic photodetectors that convert the optical soliton pulses to rapid single-flux-quantum (RSFQ) pulses. Suitable superconducting photodetectors are described in Ultrafast dynamics if Nonequilibrium Quasiparticles in High-Temperature Superconductors, by R. Sobolewski et al., Proc. SPIE 3481, 480-491 (1998), which is incorporated herein by reference; and in U.S. Pat. No. 5,963,351 (Kaplounenko et al.), which is incorporated herein by reference. The RSFQ pulses generated by the ORs 12 can subsequently be processed by the remaining superconducting logic circuits in the high-speed section 10. Preferably, each of the ORs 12 also includes clock recovery and thresholding circuitry (not shown), so that the RSFQ pulses correspond to the optical soliton pulses.

Destination information is preferably extracted from the data packet by capturing a copy of the header of each packet in the superconducting header reader 13. In communication protocols that precede each header with an escape sequence, capturing of the header may be implemented by having the superconducting circuits watch the incoming data stream for an occurrence of the escape sequence, and capture the appropriate number of bytes that follow the escape sequence. For example, in the Internet point to point protocol (PPP), where the escape sequence is followed by a four byte header, the four bytes that follow the escape sequence would be captured into the header reader 13. The header reader 13 is preferably implemented using a superconducting shift register. When a header contains only destination information, the entire header is preferably captured in the header reader 13. In protocols where the header contains other information besides the destination information, capturing that other information into the header reader 13 is optional.

In addition, the entire incoming data packet, including the header, is delayed in the superconducting FIFO 14. The FIFO 14 may be implemented, for example, using a superconducting shift register, a passive superconducting transmission delay line, or a superconducting Josephson transmission line (JTL). The required delay time (or storage capacity) of the FIFO 14 is calculated below. In alternative preferred embodiments, the header need not be stored in the FIFO 14, as long as the entire packet is subsequently reassembled into its original form before it arrives at the crossbar switch 15. The superconducting electronics in the high-speed section 10 operate at the “wire rate” (i.e. the rate at which bits of data are received from the fiber).

Once the packet header (or the relevant portion thereof) has been captured in the header reader 13, it is sent to the controller 18, which is implemented in a suitable non-superconducting semiconductor technology. The signal connection between the superconducting header reader 13 and the non-superconducting controller 18 may be implemented using an optical data link (e.g., electro-optical converter EO 19 in conjunction with a corresponding converter (not shown) in the controller 18). Optionally, the data may be serialized before being transmitted over the optical data link. In alternative embodiments, if the superconductor's cooling system can tolerate the heat load associated with a direct connection between the superconducting header reader 13 and the non-superconducting controller 18, the optical data link may be replaced with an electrical connection.

The controller 18 contains an address table that enables it to determine the best route for a packet based on the destination information that has been extracted from the packet. Referencing such address tables is a commonly used technique in routers. In contrast to the high-speed section 10, which operates at the wire rate, the controller 18 only receives one address for each incoming packet. As a result, the controller 18 can operate at the packet rate, i.e., the rate at which packets are transmitted through the switch. This packet rate is much slower than the wire rate. For Internet communications, where the minimum packet size is about 64 bytes, the controller 18 can operates at 1/512 of the speed of the high-speed section 10. So if the “wire rate” is 160 Gbps, then nonsuperconducting electronics in the controller need process only 310 million packets per second (per input). Because the controller only has to process 310 million decisions per second, the controller can be implemented using conventional semiconductors (e.g., silicon) operating at room temperature. This provides a tremendous advantage, because large silicon-based memories are extremely inexpensive to build and operate. In contrast, implementing a controller with equivalent functionality in superconducting circuits would be either prohibitively expensive or impossible.

After the controller 18 determines where to send the packet, the controller 18 sends appropriate control signals into the high-speed section 10 to set the crossbar switch 15. In the illustrated embodiment, those control signals are passed from the non-superconducting controller 18 to the control input of the superconducting crossbar switch 15 using an optical data link (e.g., an EO (not shown) in the controller in conjunction with a corresponding opto-electrical converter OE 20). Optionally, the data may be serialized before being transmitted over the optical data link. In alternative embodiments, if the superconductor's cooling system can tolerate the heat load associated with a direct connection between the controller 18 and the crossbar switch 15, the optical data link may be replaced with an electrical connection.

The superconducting crossbar switch 15 may be implemented, for example, using RSFQ logic in a manner similar to the switching arrangement described in Zinoviev, except that instead of selecting an output port based on bits that are received together with the packet, the output port is selected based on control signals received from the controller 18 via a control input. Implementing superconducting switching is also discussed in CNET: RSFQ Switching Network for Petaflops-Scale Computing, by L. Wittie et al., IEEE Trans. on Appl. Supercond. 9, No. 2, 4034-4039 (1999), which is incorporated herein by reference. In response to these control signals, the crossbar switch 15 sets up a path that will route the incoming packet to the output port that was chosen by the controller 18.

While the illustrated embodiment uses a switch 15 with a crossbar architecture, various alternative architectures may be substituted therefor (e.g., a Banyan switcher core, single or multi-stage crosspoint arrays, or any other coordinate switch). The Banyan architecture has the advantage that only log₂N control signals are needed to set an N×N switch.

After the crossbar switch 15 has set up the path that will route the incoming packet to the output port that was chosen by the controller 18 (including any required settling time for the switch), the delayed version of the data packet (which was delayed in the superconducting FIFO 14) arrives at an input of the crossbar switch 15. The crossbar switch 15 then routes this delayed version of the data packet to the appropriate port.

The RSFQ outputs of the crossbar switch 15 are preferably converted to optical soliton pulses in high-speed electro-optical transmitters (EO) 16. This high-speed EO 16 is preferably implemented using a continuously-on laser source combined with a current-driven external electro-optic modulator. Examples of suitable external modulators for this purpose include, but are not limited to, magneto-optic modulators such as those described in Magneto-Optical Modulator for Superconducting Digital Output Interface, by R. Sobolewki and J. Park (IEEE Trans. on Appl. Supercon., Vol. 11, No. 1, March 2001), which is incorporated herein by reference; and intensity-modulation modulators such as those described in U.S. Pat. Nos. 5,210,637 (Puzey) and 5,110,792 (Nakayama et al.), each of which is incorporated herein by reference. In alternative embodiments, the electro-optical transmitters may be implemented using direct modulation of lasers or electro-absorption modulators. In other alternative embodiments, electro-optical transmitters that produce different types of pulses (i.e., other than solitons) may be used.

Lithium niobate electro-optic modulators can also be used as the EO 16, as they can operate successfully at cryogenic temperatures. One example of a suitable preamplifier for driving these modulators is a cascade of a JTL amplifier (such as those made by Hypres) and an InP or GaAs High electron mobility transistor (HEMT) amplifier chip. That combination should provide sufficient gain to drive the electro-optic modulators so that they produce a 2% index of modulation, which would provide a 20 dB signal-to-noise ratio using a 10 mW C.W. laser to drive the modulator.

The modulated optical output of the EO 16 is then amplified in a conventional erbium-doped fiber amplifier (EDFA) 17 for transmission over an optical fiber (not shown), preferably at the standard 1.5 μm wavelength that is commonly used for fiber-optic transmission. In cases when the electro-optical modulator (EO) 16 must be operated at a different wavelength, a non-linear optical crystal may be used to convert the modulated radiation from that wavelength to 1.5 μm for use in the remainder of the standard communications system. Examples of suitable nonlinear crystals for this purpose include, but are not limited to, ZnTe, DAST, and GaP. Either sum or difference frequency generation may be utilized.

The size of the FIFO 14 must be sufficient to enable the router to complete the following five operations before the delayed version of the data packet arrives at the crossbar switch 15: (1) synchronize the clock; (2) capture the address in the header reader 13; (3) send the address from the header reader 13 to the controller 18; (4) have the controller 18 look up the destination port from an address table (not shown) and send appropriate control signals back to the crossbar switch 15; and (5) wait for the crossbar switch 15 to respond to the control signals and settle. If the delay provided by the FIFO 14 large enough for all five of these operations to occur, the crossbar switch 15 will be settled into its new position before the delayed version of the data packet arrives. The delayed version of the data packet will therefore be routed to the correct output port. Commercial network processors are currently available with 16 nS lookup time. Assuming that this lookup time determines the packet processing rate and that all five operations are executed in a synchronous pipeline, then the required delay of the FIFO 14 would be approximately:

5 operations×16 nS=80 nS

For example, if a shift register type FIFO is used at a data rate of 160 Gbps, this delay would translate to

80 nS×160 Gbps=13 kilobits.

Thus, a 13 kilobit shift register FIFO 14 would be sufficiently large in this example.

The maximum clock frequency for RSFQ logic is limited by, among other things, the minimum dimensions of the Josephson junctions. For state-of-the-art niobium Josephson junctions, this limit is approximately 80 GHz per μm. Therefore, in order to achieve a clock speed of 160 Gbps, the SCE circuits should be built with junctions that are no larger than 0.5 Am. This is well within the capability of commercial photolithography and the state of the art in niobium RSFQ devices. The superconducting chip may be fabricated, for example, using a 10-kA/cm² niobium tri-layer process with a time constant (t₀) of about 0.44 pS. This would enable operation at a device frequency of approximately 380 GHz. Optionally, parallelism may be used to increase the throughput of the superconducting circuits.

The state of the art in density, size, and complexity of SFQ circuits is 10,000 Josephson Junctions per square centimeter. Therefore, it is practical to fabricate the 13-kilobit FIFO JTL memory on a single chip.

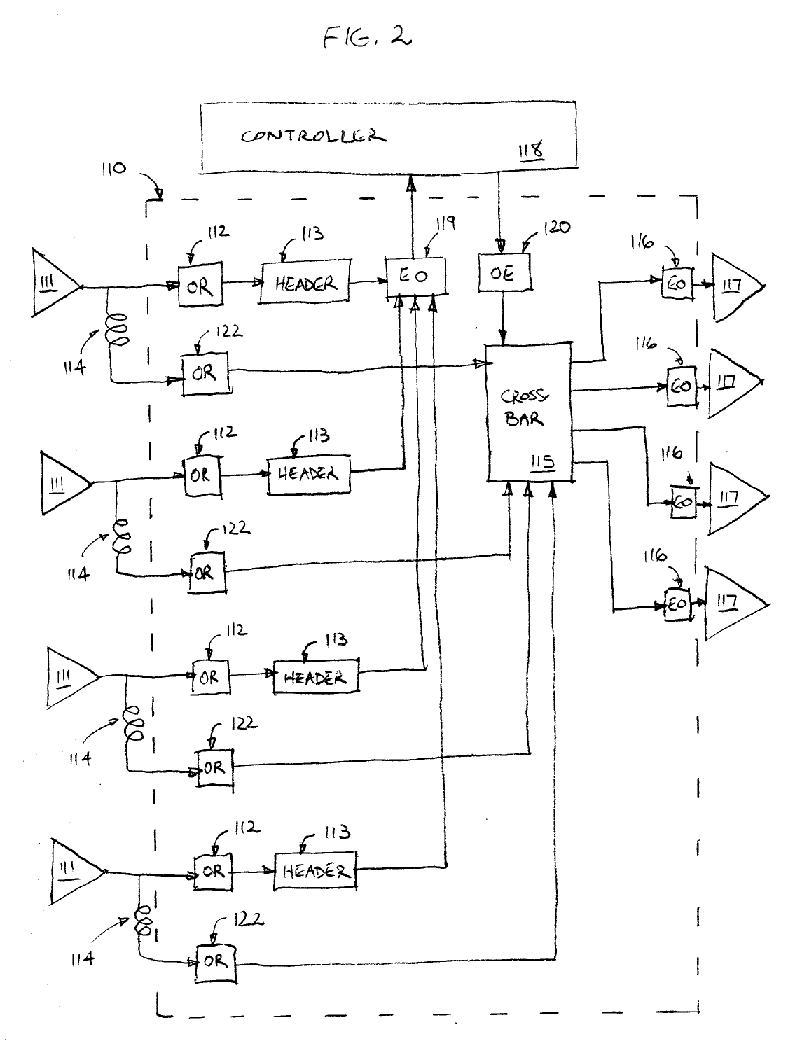

FIG. 2 is a block diagram of alternative embodiments that uses a fiber optic delay line to delay the arrival of the data packet at the superconducting switch. The operation of the Raman amplifier 111, the optical receiver 112, the header reader 113, the switch 115, the EOs 116, the EDFAs 117, the controller 118, the EO 119, and the OE 120 is similar to the correspondingly numbered items 11-13 and 15-20 of the FIG. 1 embodiment described above. However, instead of using a superconducting FIFO 14 as shown in the FIG. 1 embodiment, a fiber optic delay line (FODL) 114 is used to delay the arrival of the data packet at the superconducting switch until after that switch has been configured to route the data packet to its desired destination.

In the FIG. 2 embodiment, the fiber optic delay lines 114 are driven by the same Raman amplifiers 111 that drive the optical receivers 12. Destination information is extracted in the header reader 113 and passed to the controller 118, and the controller sends control signals to configure the switch 118 to a desired state as in the FIG. 1 embodiment. Meanwhile, during the time it takes for all this to occur, a second copy of the data packet is traveling through the FODL 114. By the time this second copy of the data packet arrives at the output end of the FODL 114, the switch is already set up to route the delayed version of the data packet to the desired destination. The required amount of delay is the same as in the FIG. 1 embodiment.

Because the delay is implemented in the optical domain, it is necessary to convert the optical signals that come out of the FODL 114 into RSFQ pulses before they can be processed by the superconducting switch 115. This is accomplished by a second set of optical receivers 122, which are similar to the optical receivers described above in connection with the FIG. 1 embodiment. After the point where the delayed version of the data packet arrives at the input of the superconducting switch 115, the operation of the FIG. 2 embodiment is the same as the FIG. 1 embodiment described above.

Notably, the routers in the embodiments described above have a flow-through architecture because the delayed version of the data packet need never be examined by the router. This architecture enables the data packet to be routed through the relatively inexpensive FIFO 14 (in contrast to the conventional store—and forward architecture, where the data is typically stored in a RAM). Only the header, which is a very small portion of the data packet and requires a relatively small amount of memory to store, has to be stored in a manner that permits examination. This is particularly important in the context of superconducting circuits, where implementing large memories is difficult and costly.

The embodiments described above can be used to switch data signals having data rates up to 160 Gbps using existing state-of-the-art components. It is expected that evolutionary changes in the underlying technologies will ultimately enable the above-described architecture to switch 640 Gbps signals, and eventually 2.56 Tbps signals. Moreover, unlike the prior art DWDM systems, because the above-described technology will not be operating near the theoretical limits of the technologies being used, costs will not increase in direct proportion to capacity when each new generation is introduced.

Optionally, the above-described techniques may be combined with wavelength division multiplexing (e.g., by sending a plurality of 160 Gbps over a single fiber on different channels).

While the present invention has been explained in the context of the preferred embodiments described above, it is to be understood that various changes may be made to those embodiments, and various equivalents may be substituted, without departing from the spirit or scope of the invention, as will be apparent to persons skilled in the relevant art.

I claim:

1. An apparatus for routing packets of digital data comprising:
a superconducting switch having a first input port, a plurality of output ports, and a control input, wherein the superconducting switch routes data packets from the first input port to any of the plurality of output ports, and wherein the output port to which the data packets are routed depends on a control input;
a superconducting data reader that extracts destination information from an incoming data packet at a reference time;
a controller, implemented in non-superconducting technology, that (a) chooses, based on the extracted destination information, one of the plurality of output ports and (b) sends a control signal to the control input of the superconducting switch, wherein the control signal configures the superconducting switch to route the incoming data packet to the chosen output port; and
a delay element that delays the arrival of the incoming data packet at the superconducting switch with respect to the reference time until after the superconducting switch has been configured to route the incoming data packet to the chosen output port.

2. The apparatus of claim 1, wherein the superconducting switch also has a second input port, and wherein the superconducting switch routes data packets from the second input port to any of the plurality of output ports.

3. The apparatus of claim 1, wherein the superconducting switch comprises a crossbar switch.

4. The apparatus of claim 1, wherein the superconducting switch comprises a Banyan switch.

5. The apparatus of claim 1, wherein the superconducting data reader comprises a shift register.

6. The apparatus of claim 1, wherein the controller chooses which of the plurality of output ports the incoming data packet should be routed to by using the extracted destination information as an index into a look-up table.

7. The apparatus of claim 1, wherein the destination information is transmitted from the superconducting data reader to the controller via an optical data link.

8. The apparatus of claim 7, wherein the control signal is transmitted from the controller to the superconducting switch via an optical data link.

9. The apparatus of claim 1, wherein the delay element comprises a fiber optic delay line.

10. The apparatus of claim 1, wherein the delay element comprises a superconducting circuit.

11. The apparatus of claim 1, further comprising:
an optical receiver that converts the incoming data packet from optical pulses to RSFQ pulses, and provides the RSFQ pulses to the superconducting data reader and the delay element; and
an optical transmitter that converts RSFQ output signals from the superconducting switch's output ports to optical signals.

12. The apparatus of claim 1,
wherein the delay element comprises a fiber optic delay line, and wherein the apparatus further comprises:
a first optical receiver that converts the incoming data packet from optical pulses to RSFQ pulses, and provides the RSFQ pulses to the superconducting data reader;
a second optical receiver that converts the delayed data packet from optical pulses to RSFQ pulses, and provides the RSFQ pulses to the superconducting switch's input ports; and
an optical transmitter that converts RSFQ output signals from the superconducting switch's output ports to optical signals.

13. An apparatus for routing a data packet to a destination comprising:
superconducting circuitry having at least one input and a plurality of outputs; and
a nonsuperconducting controller,
wherein the superconducting circuitry extracts destination information from the data packet and sends the extracted destination information to the nonsuperconducting controller,
wherein the controller (a) selects, based on destination information sent from the superconducting circuitry, one of the plurality of output ports, and (b) sends an instruction to the superconducting circuitry to route the data packet to the selected output port, and
wherein the superconducting circuitry routes the data packet to the selected output port in accordance with the instruction sent from the controller.

14. The apparatus of claim 13, wherein the superconducting circuitry comprises switching circuitry and destination extraction circuitry, and wherein the data packet's arrival at the switching circuitry is delayed with respect the data packet's arrival at the destination extraction circuitry.

15. The apparatus of claim 14, wherein a fiber optic delay line is used to delay the data packet's arrival at the switching circuitry with respect the data packet's arrival at the destination extraction circuitry.

16. The apparatus of claim 14, a superconducting circuit is used to delay the data packet's arrival at the switching circuitry with respect the data packet's arrival at the destination extraction circuitry.

17. The apparatus of claim 14, wherein the switching circuitry has a crossbar architecture.

18. The apparatus of claim 14, wherein the switching circuitry has a Banyan architecture.

19. The apparatus of claim 14, wherein the controller chooses which of the plurality of output ports the incoming data packet should be routed to by using the extracted destination information as an index into a look-up table.

20. The apparatus of claim 14, wherein the controller selects one of the plurality of output ports by using the destination information as an index into a look-up table.

21. The apparatus of claim 14, wherein the at least one input of the superconducting circuitry is fed by at least one optical receiver, and the plurality of outputs of the superconducting circuitry is fed into a plurality of optical transmitters.

22. A method of routing a data packet through a switch having a plurality of output ports, the method comprising the steps of:
extracting destination information from the data packet;
selecting one of the plurality of output ports for the data packet by using the extracted destination information as an index into a look-up table;
generating a delayed version of the data packet using a delay element having a flow-through architecture;
providing the delayed version of the data packet to a switch; and
instructing the switch, before the delayed version of the data packet arrives at the switch, to route the delayed version of the data packet to the output port selected in the selecting step,
wherein the extracting step is performed using superconducting circuitry, and the selecting step is performed using nonsuperconducting circuitry.

23. The method of claim 22, wherein the generating step is performed using a fiber optic delay line.

24. The method of claim 22, wherein the generating step is performed using a superconducting circuit.

25. The method of claim 22, further comprising the steps of converting incoming data from optical signals to RSFQ signals, and converting outgoing data from RSFQ signals to optical signals.
